(19) United States
(12) Patent Application Publication
(10) Pub. No.: US 2016/0238380 A1
(43) Pub. Date: Aug. 18, 2016

(54) IMAGE MEASURING METHOD AND IMAGE MEASURING APPARATUS

(71) Applicant: CANON KABUSHIKI KAISHA, Tokyo (JP)

(72) Inventors: Akihiro Hatada, Utsunomiya-shi (JP); Takanori Uemura, Saitama-shi (JP); Yoshiyuki Kuramoto, Utsunomiya-shi (JP)

(21) Appl. No.: 15/019,067

(22) Filed: Feb. 9, 2016

(30) Foreign Application Priority Data
Feb. 12, 2015 (JP) 2015-024911

(51) Int. Cl. G01B 11/24; G01B 11/06

(52) U.S. Cl. CPC G01B 11/2441; G01B 11/06

(57) ABSTRACT

An image measuring method for imaging an object to be measured having a horizontal plurality of planes, on which the object to be measured is mounted and calculating a shape of the object to be measured based on the image of the object to be measured is provided that includes measuring a height of the object to be measured at a plurality of positions of the plurality of planes on the object to be measured; calculating positions of the plurality of planes based on the height measured in the measuring; aligning the focus position with each of the plurality of planes calculated in the calculating and imaging of the object to be measured; and calculating the shape of the object to be measured based on the image of the object to be measured imaged in the imaging.

### BACKGROUND OF THE INVENTION

1. Field of the Invention

The invention relates to an image measuring method and an image measuring apparatus, in particular, the image measuring method that enables a shape measurement of an object to be measured.

2. Description of the Related Art

An image measuring apparatus that measures XY dimensions of an object to be measured detects an edge by acquiring an image of the object to be measured and performing an image processing to thereby perform an XY dimension measurement by calculating a distance between the detected plurality of edges. Also, in an image measurement, the entire object to be measured needs to be imaged in focus for a high-accuracy measurement. Since there is a limitation in depth of focus during an image acquisition by the camera, the entire plan of the object to be measured can be imaged clearly if the object to be measured has a planar shape and entire upper surface thereof falls within the depth of focus. However, if the object to be measured has a large height dimension and does not fall within the depth of focus, a portion which is outside of the depth of focus is a blurred image, and thus the edge cannot be detected with high accuracy and the dimension measurement is difficult. Therefore, a technique for setting a measuring point by focusing on the portion to be measured of the object to be measured has been taken.

As the means for focusing the object to be measured, a contrast method and the like is known. The contrast method is a method for calculating the contrast of image data from the image data acquired by imaging a workpiece using an imaging pickup apparatus and determining the position, at which the contrast is maximized, to the object to be measured of an imaging system. However, in such focusing method, since focus detection is performed base on the image data acquired by an imaging element such as a CCD camera, the measuring time is limited by the frame rate of the imaging element. As the result, it takes long time to calculate the contrast from even more data of pixels.

In order to solve the above, for example, Japanese Patent Laid-Open No. H08-226805 discloses a method for detecting focus position at high speed using a line sensor and the like, which enables acquiring the data at a high speed at a position coordinated with the camera, provided separately from an image obtaining camera. In addition, Japanese Patent Laid-Open No. 2001-336916 discloses the method for measuring the image of the object to be measured by a television camera for each sampling interval which has been predetermined in advance while moving an object lens in a direction perpendicular to an installation surface of the object to be measured. The method for detecting the edge of the object to be measured from a differential image calculated from the acquired image is disclosed. Furthermore, Japanese Patent Laid-Open No. 2004-198274 discloses a shape measuring method by using a laser autofocus and the method for calculating the height from a movement amount in the focus direction of the object lens by scanning the object to be measured in the XY direction while autofocusing by the object lens.

However, in the method disclosed in Japanese Patent Laid-Open No. H08-226805 and Japanese Patent Laid-Open No. 2001-336916, since the operation itself that determines the focus position separately from the actual dimension measurement is needed, the measurement cannot be performed in a short time. In addition, in the method disclosed in Japanese Patent Laid-Open No. 2004-198274, the shape measurement is performed while autofocusing. However, since the measurement is performed while scanning the measurement point, high-density data is needed when the measurement is performed with high accuracy, and thus the measurement cannot be performed at short time.

### SUMMARY OF THE INVENTION

The present invention provides an image measuring method for detecting the edge of the object to be measured in a short time without causing any deterioration of the accuracy of the edge detection of the object to be measured.

According to the invention, an image measuring method for imaging an object to be measured that has a horizontal plurality of planes on which the object to be measured is mounted and calculating a shape of the object to be measured based on the image of the object to be measured is provided that includes measuring a height of the object to be measured at a plurality of positions of the plurality of planes on the object to be measured; calculating positions of the plurality of planes based on the height measured in the measuring; aligning the focus position with each of the plurality of planes calculated in the calculating and imaging the object to be measured; and calculating the shape of the object to be measured based on the image of the object to be measured that is imaged in the imaging.

According to the invention, the image measuring method for measuring the height of the object to be measured in a single measurement, determining the focus position using the result of the height measurement, and detecting the edge of the object to be measured with a high accuracy and in the short time can be provided.

Further features of the invention will become apparent from the following description of exemplary embodiments with reference to the attached drawings.

### BRIEF DESCRIPTION OF THE DRAWINGS

FIG. 1 is a diagram illustrating an image measuring system according to an embodiment of the present invention.

FIG. 2 is a flowchart illustrating a measuring processing according to an embodiment of the present invention.

FIG. 3 is a diagram illustrating a measuring result according to an embodiment of the present invention.

FIGS. 4A to 4C are diagrams illustrating a measured image of the object to be measured.

FIG. 5 is diagram illustrating the measuring processing according to an embodiment of the present invention.

DESCRIPTION OF THE EMBODIMENTS

Hereinafter, preferred embodiments of the invention will be described with reference to the drawings.

### First Embodiment

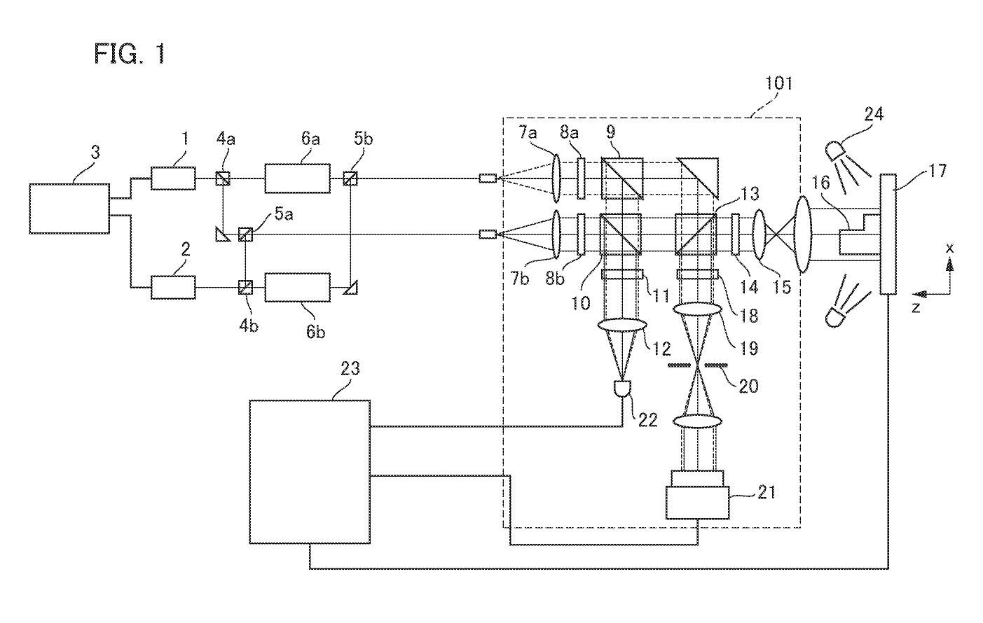

First, the description of an image measuring apparatus according to the present embodiment will be given with reference to FIG. 1. The image measuring apparatus comprises a measuring unit configured to measure a height of an object to be measured, and in the present embodiment, a multi-wavelength interferometer is adopted as the measuring unit. A light source 1 and a light source 2 are controlled by a controller 3 by setting an absorption line of a sealed gas of a gas cell (not shown), a transmission spectrum of a Fabry-Perot etalon or the like as a reference of the wavelength so as to stabilize a wavelength. Light flux emitted from the light source 1 and the light source 2 is split by beam splitters 4a and 4b. The one is transmitted through a wavelength shifter 6a or 6b and is multiplexed by a multiplexing unit 5a to thereby become a second light flux, the other is multiplexed by a multiplexing unit 5b to thereby become a first light flux.

Next, the first light flux and the second light flux are each incident to an interferometer 101. Then, the first light flux which is incident to the interferometer 101 is to be a parallel light flux, and a polarization direction thereof is adjusted by a polarization adjusting element 8a such as a ½ wavelength plate so as to match a transmission polarization angle of a polarization beam splitter (hereinafter, referred to as “PBS”) 13. Similarly, the second light flux is to be the parallel light flux, and the polarization direction thereof is then adjusted by a polarization adjusting element 8b so as to match the transmission polarization angle of the PBS 13. Transmitted light of the second light flux is transmitted through the PBS 13, and is then circularly-polarized by a ¼ wavelength plate 14 to be the parallel light flux by an object lens 15. Next, the light flux is irradiated to an object to be measured 16 mounted on a Z-axis driving stage 17, which is drivable in a direction of an optical axis. Reflected light or scattered light (light to be measured) from the object to be measured transmitted through the ¼ wavelength plate 14 again to be linear polarized light of which a polarization plane is rotated by 90° at the time of incidence, and is then reflected by the PBS 13 to be coupled with the first light flux.

Light emitted from PBS 13 is cut out the interference signal by a polarizer 18. An iris diaphragm 20 is arranged at the position coordinated with a pupil plane of the object lens within an imaging optical system 19. Furthermore, a beat signal corresponding to the frequency difference of the light flux is detected by a detector 21 such as the CCD camera and the CMOS camera arranged by the relationship coordinated with the object to be measured, and is then input as the detected signal to an analyzer 23, which is the means for calculating the height of the object to be measured. Note that, the analyzer 23 also functions as the means for controlling entire image measuring apparatus, a height measuring unit configured to measure the height, and a calculating unit configured to calculate a plurality of planes of the object to be measured based on the measured height.

Furthermore, the reflected light of the first light flux due to the beam splitter 9 and the reflected light (reference light) of the second light flux due to the beam splitter 10 are coupled by the beam splitter 10. Then, this light is transmitted through the polarizer 11 and the imaging optical system 12, and the beat signal corresponding to the frequency difference of the both light flux is detected by a detector 22 to input to the analyzer 23 as the reference interference signal.

The height of the object to be measured is calculated by a phase difference 01, a phase difference 02, and a synthetic wavelength λ12 of a wavelength λ1 and a wavelength λ2 emitted from the light source 1 and the light source 2 in the analyzer 23. The synthetic wavelength λ12 is a synthetic wavelength |λ1λ2/(λ1+λ2)═ generated by the wavelength λ1 and the wavelength λ2, and if ng (λ1, λ2) is a group refractive index in the wavelength λ1 and the wavelength λ2, the height of the object to be measured is represented by the following formula. The above is a system configuration which is the means for performing the height measurement of the object to be measured.

$$D ( x , y ) = \frac{{Λ}_{12}}{2 ng ( {λ}_{1} , {λ}_{2} )} ( \frac{{φ}_{2} ( x , y ) - {φ}_{1} ( x , y )}{2 π} ) \qquad [ formula 1 ]$$

Next, the description of a system configuration of an image measurement according to the present embodiment will be given. The image measurement system is configured to add an incoherent light source 24 to a height measuring unit. The incoherent light source 24 is a light source in which a plurality of light source elements are arranged in a ring shape. Therefore, the object to be measured 16 can be illuminated from a desired direction. Light which is emitted by the incoherent light source 24 is reflected and scattered by the object to be measured 16, and is then focused by the object lens 15. Furthermore, the object to be measured 16 and the detector 21 are in the coordinated relationship, and a two-dimensional image is acquired. A resolution can be adjusted by adjusting the diameter of an iris diaphragm 20 located inside the object lens or the imaging lens optical system. The two-dimensional image acquired by the detector 21 is transmitted to the analyzer 23, is image processed, and then the dimension measurement is performed by the edge detection.

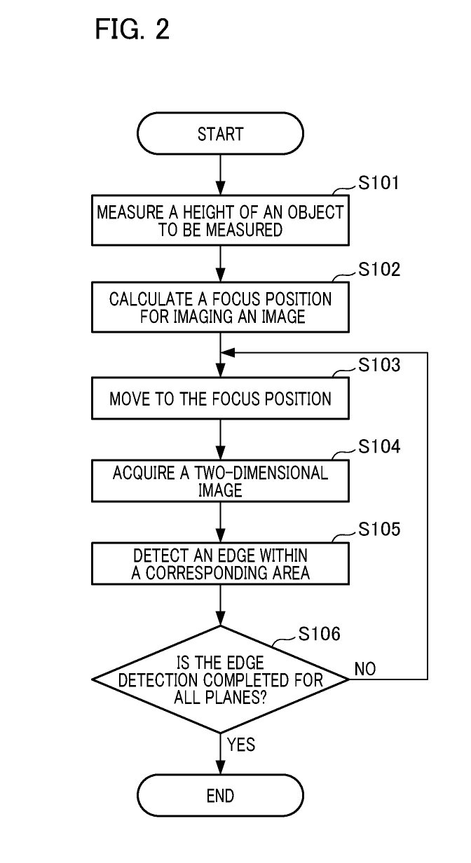

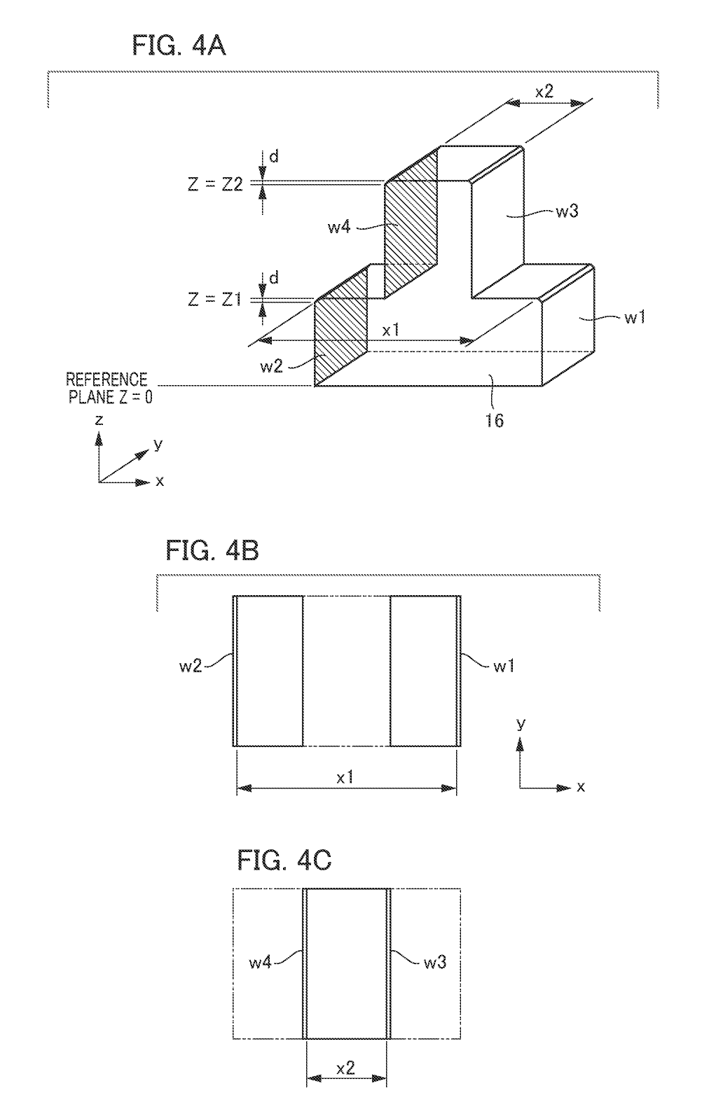

Next, the description of the measuring processing according to the present embodiment will be given with reference to FIG. 2. In the present embodiment, for example, the object to be measured as shown in FIG. 4 described below is assumed, and the desired dimensions to be measured are set to x1 and x2. In order to obtain the dimensions of x1 and x2, the edges corresponding to an outline of the side surfaces w1, w2, w3, and w4 of the object to be measured are detected. Note that, in the present embodiment, the analyzer 23 performs the processing.

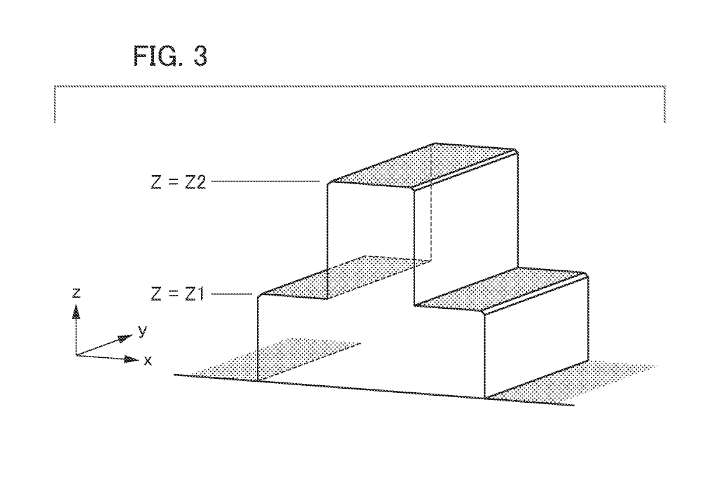

Firstly, in step S101, the height measuring unit of the object to be measured measures the height of the object to be measured 16. The height measuring unit acquires point group data indicating the position of the surface of the object to be measured, as shown in FIG. 3. Typically, the edge for the dimension measurement is formed by a plurality of planes having different heights as shown in FIG. 3. Therefore, the focus position (plane), which is suitable for the edge detection, corresponding to the shape of the plane to be measured can be determined by detecting the height of the plane at the plurality of positions. More specifically, on the basis of the plane perpendicular to the optical axis, the point group data in FIG. 3 is divided into a set of the point groups within an arbitrary height range, and a planar fitting is performed for each set. By setting the height of the reference plane on which the plane to be measured is mounted as the origin, a plurality of plane height Z1, Z2 of the plane to be measured obtained by the fitting are calculated. In the present embodiment, by using the height detecting unit that can measure the height of the plurality of planes, the focus position of the object to be measured, which is formed by the plurality of heights, can be measured without moving the object to be measured, unlike the conventional laser focusing system. Therefore, it is extremely effective particularly for speeding-up the image measuring apparatus with the wide field of view.

Next, in step S102, the focus position (plane) for the edge detection is determined based on the plane height in step S101. Generally, since the ridge line forming the edge is chamfered, in the present embodiment, the focus position is determined by taking into consideration a chamfering amount. More specifically, the focus position is determined as a position (Z1-d and Z2-d) below the plane height only by an offset d, which is larger than the chamfering amount. The offset d is configured to be input from a measuring parameter and to be adjustable in accordance with the object to be measured. In addition, if the effect of the chamfer can be ignored, the offset d is not necessary. Therefore, since the focus position is determined, a focus error due to the chamfered plane and the like by means of detecting a best contrast position by shaking the focus can be prevented, and thus the highly accurate measurement can be performed.

Next, in step S103, the imaging system is adjusted to the focus position that has been detected and calculated in step S102. In the present embodiment, the object to be measured is moved on a Z-axis driving stage, and the focus is adjusted by matching the height of Z1-d or Z2-d with the coordinate plane at the side of the object to be measured of the imaging system. The camera may be moved instead of moving the object to be measured, and the distance between object images of the imaging system may be adjusted. Furthermore, the object to be measured 16 is moved in the optical axis direction at the plane heights Z1 and Z2 of the object to be measured, and the focus position focused on plane to be measured is moved.

Next, in step S104, the imaging unit (not shown) performs the imaging in the state in which the focus adjustment is performed in step S103. Note that, in order to accurately detect the edge position in a subsequent step, it is desirable to select the illumination having a high contrast. A known technique may be used for the illumination method. For example, if the edge corresponding to the outline of the object to be measured is detected, the transmitted illumination is known to be suitable. A coaxial incident illumination and a ring illumination are used as the other reflection illumination. These lighting conditions may be set by the user during the measurement, and the imaging may be performed in the plurality of illumination conditions to select the image having the best contrast during the edge detection. Also, the transmitted illumination may be automatically detected by automatically detecting the edge corresponding to the outline form the height information in step S101.

Next, in step S105, the edge detection is performed based on the image acquired in step S104. In step S104, the image focused on each of the plane heights Z1 and Z2 is acquired as shown in FIGS. 4B and 4C. Here, in each drawing, the solid line part indicates the plane in focus, and the dotted line part indicates the plane out of focus. Since the accuracy has significantly deteriorated at the dotted line part that is out of focus in the XY dimension measurement, it is necessary to measure the distance between the solid line parts in the plane that is in focus. Therefore, the edge detection is performed at the thick solid line part in FIGS. 4B and 4C of the image acquired in step S104, i.e. at the side planes w1, w2, w3, and w4. A known technique may be used as the edge detection method. For example, a known technique may be a method for calculating the strength of the edge by calculating a gradient using the first derivation value of the image and finding the point having the locally maximum value in the direction of the gradient, and a method for finding the point having a zero tolerance in a quadratic differential formula calculated based on the image.

Next, in step S106, it is determined whether or not the edge detection is completed for all planes detected in step S102. If it is determined that the edge detection is completed for all planes (Yes), the detection ends. On the other hand, if it is determined that the edge detection is not completed for all planes (No), the processing returns to step S103 to repeat the measurement again. Note that, it is not necessary to perform the edge detection (measurement) for all planes, and the number of planes for measuring may be limited by the user setting the number in advance.

As described the above, the description of the measuring method according to the present embodiment has been given. However, it is not limited to the two wavelength interferometers serving as the multi-wavelength interferometer, and, for example, it may be the multi-wavelength interferometer having a plurality of wavelengths that is more than three different wavelengths. Also, it may be the multi-wavelength interferometer that enables an absolute length measurement by wavelength scanning one of the plurality of wavelengths. Furthermore, a white interferometer using a white LED and a low coherent light source as the light source and the measuring unit in known example may be used. In addition, in the present embodiment, it has been disclosed that the focus adjustment mechanism adjusts the focus position by moving the mounting table of the object to be measured in the direction of the optical axis. However, the focus adjustment mechanism may adjust the focus position by moving the detector or the optical system such as the object lens of camera and the like.

As described the above, according to the present embodiment, the image measuring method for measuring the height of the object to be measured in the single measurement, determining the focus position using the result of the height measurement, and detecting the edge of the object to be measured with high accuracy and at the short time can be provided.

### Second Embodiment

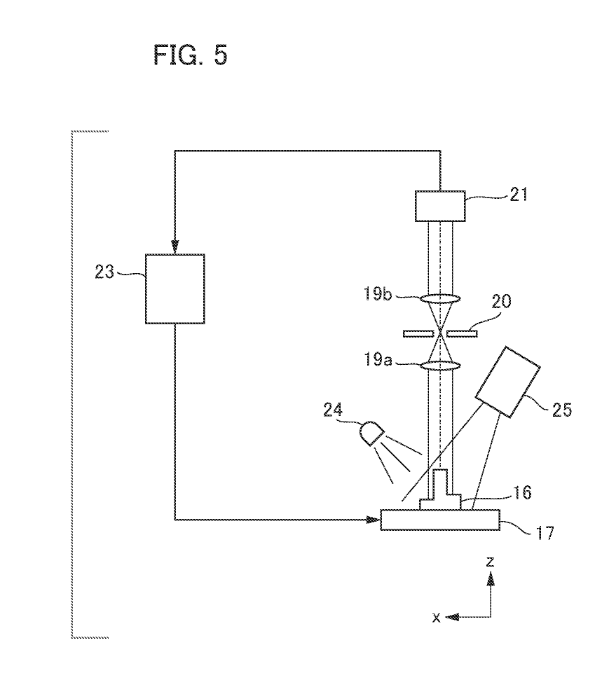

In the present embodiment, unlike the first embodiment, the description of the system mechanism for height measurement based on the principle of a pattern projecting method as shown in FIG. 5 will be given. Here, the pattern projecting method is a method, using the system consisting of such as a projector and a photodetector for projecting a pattern, for projecting the known pattern to the object to be measured, and calculating the three-dimensional point group data from the distortion amount of the pattern caused by the shape of the object to be measured. Generally, the data amount and the measuring time of the three-dimensional point group data are in a trade-off relationship. In addition, for the height detection of the plane, since the density of the point group data is not needed in the high accurate edge detection, the height measurement of the object to be measured can be performed at a high speed, and for the accurate edge detection, the data may be densely acquired.

The image measuring apparatus of the present embodiment has a projector 25, and projects the known pattern to the object to be measured. The pattern which is illuminated by the incoherent light source 24 and is distorted by the shape of the object to be measured 16 is imaged on the detector 21 by the imaging optical systems 19a and 19b and the iris diaphragm 20 at the position conjugated with the pupil plane of the object lens of the imaging optical systems 19a and 19b. The image acquired by the detector 21 is transmitted to the analyzer 23. The analyzer 23 calculates the distortion amount based on the known pattern based on the image, acquires the three-dimensional point group data of the object to be measured, and acquires the height information of the object to be measured.

Subsequently, the dimension and geometric tolerance can be calculated with high accuracy and in a short time by adapting the same method as the first embodiment for the system configuration of the image measurement and the measurement processing. Therefore, according to the present embodiment, the image measuring method for measuring the height of the object to be measured in the single measurement, determining the focus position using the result of the height measurement, and detecting the edge of the object to be measured with high accuracy and in a short time can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-024911, filed Feb. 12, 2015, which is hereby incorporated by reference herein in its entirety.

What is claimed is:

1. An image measuring method for imaging an object to be measured having a horizontal plurality of planes on which the object to be measured is mounted and calculating a shape of the object to be measured based on the image of the object to be measured, the method comprising:
measuring a height of the object to be measured at a plurality of positions of the plurality of planes on the object to be measured;
calculating positions of the plurality of planes based on the height measured in the measuring;
aligning the focus position with each of the plurality of planes calculated in the calculating and imaging the object to be measured; and
calculating the shape of the object to be measured based on the image of the object to be measured imaged in the imaging.

2. The image measuring method according to claim 1, wherein in the measuring, the height of the object to be measured is measured by setting a plane on which the object to be measured as a reference plane and setting the reference plane as an origin.

3. The image processing apparatus according to claim 1, wherein in the measuring, the height of the object to be measured is measured using an interferometer that causes interference between a reference light and light to be measured from the object to be measured.

4. The image processing apparatus according to claim 1, wherein, in the measuring, the height of the object to be measured is measured using a pattern projection method for projecting a pattern of light to the object to be measured to measure a distortion of the pattern of the light generated by the object to be measured.

5. An image measuring apparatus that images an object to be measured having a horizontal plurality of planes on which the object to be measured is mounted and calculates a shape of the object to be measured based on the image of the object to be measured, the apparatus comprising:
a height measuring unit configured to measure a height of the object to be measured at a plurality of positions of the plurality of planes on the object to be measured;
a calculating unit configured to calculate positions of a plurality of planes based on the height measured by the height measuring unit;
an imaging unit configured to align the focus position with each of the plurality of planes calculated by the calculating unit and image the object to be measured; and
a calculating unit configured to calculate the shape of the object to be measured based on the image of the object to be measured imaged by the imaging unit.
